(19) United States
(12) Patent Application Publication
(10) Pub. No.: US 2011/0164211 A1
(43) Pub. Date: Jul. 7, 2011

(54) REFLECTIVE COLOUR DISPLAY APPARATUS

(75) Inventors: Alistair Paul CURD, Oxford (GB); Allan EVANS, Oxford (GB); Emma Jayne WALTON, Oxford (GB); Lesley Anne PARRY-JONES, Oxford (GB)

(73) Assignee: SHARP KABUSHIKI KAISHA, Osaka (JP)

(21) Appl. No.: 12/984,700

(22) Filed: Jan. 5, 2011

(30) Foreign Application Priority Data
Jan. 7, 2010 (GB) 1000176.6

(51) Int. Cl. G02F 1/1335

(52) U.S. Cl. 349/106; 349/113

(57) ABSTRACT

A reflective display comprises a pixellated display device and an optical structure which concentrates light of a plurality of colours onto pixels of a plurality of sets, respectively. Each pixel is associated with a respective sub-structure which passes light of a first colour propagating towards the pixel but which redirects light of a second colour, propagating towards the pixel, to another pixel. The display device comprises a relief structure having reconfigurable contents for modulating light.

This nonprovisional application claims priority under 35 U.S.C. §119(a) on Patent Application No. 1000176.6 filed in the United Kingdom on Jan. 7, 2010, the entire contents of which are hereby incorporated by reference.

### FIELD OF THE INVENTION

The present invention relates to a reflective colour display apparatus.

### BACKGROUND OF THE INVENTION

Reflective displays are used or desired for viewing images in settings of high ambient light. In high ambient light, they save power compared with emissive or transmissive displays because no energy is needed to create light.

Paper, coloured with pigment, is an excellent reflective display for static images, having very high reflectivity, depending on the pigment, and no limit on the viewing angle.

Electronic displays are available which can display a moving image using reflected light. These are monochrome displays, or display colour but are relatively dim compared with paper. Some principles are known which allow the brightness of these colour displays to be increased to close to that of paper, but have so far proved too difficult to implement.

Some examples of known colour reflective displays are reflective liquid crystal displays (a monochrome reflective LCD is disclosed in U.S. Pat. No. 6,577,364 published 10 Jun. 2003), electrowetting displays (see U.S. Pat. No. 7,420,549 published 2 Sep. 2008) and arrays of interference-based light modulators (see U.S. Pat. No. 5,835,255 10 Nov. 1998).

A colour reflective display is achieved by modulating the strength of the reflection of more than one colour of light.

For example, red, green and blue (RGB) modulators can be used to realise a colour, reflective, electronic display. RGB colour filters can be arranged together in pixels over a white light modulator, e.g. a reflective, monochrome LCD. The different colour filters are placed over different areas, to allow the reflections of the colours to be modulated separately. However, only one colour is transmitted through each filter and so about two thirds of the light must be absorbed by the filters, resulting in a dim display.

A similar result can be achieved using an electrowetting display, for example, as disclosed in U.S. Pat. No. 7,420,549, or any other white or single-colour light modulator.

Subtractive colour filters (usually absorbing one colour of RGB and transmitting two) can be used adjacent to each other, as mentioned in U.S. Pat. No. 7,420,549. This can increase the brightness by a factor of two, but results in loss of colour saturation.

Electrowetting can be used to control two coloured inks over the same sub-pixel area, together with subtractive colour filters, to provide an improvement compared with the reflective efficiency of a display with RGB filters side-by-side. Thus, in the case of WO03071347A, published 28 Aug. 2003, the reflective efficiency is roughly double that of a display with RGB filters, without losing colour saturation.

In the case of U.S. Pat. No. 7,359,108, published 15 Apr. 2008, the reflective efficiency (display brightness) is, in principle, no longer limited by the use of colour, since three subtractive coloured inks are used over the same sub-pixel area. However, such concepts are difficult to implement and suffer from parallax problems due to the relative dimensions of the pixels and the substrates.

WO2008/122921A1, published 16 Oct. 2008, concerns structures which are used as part of a reflective display to direct light away from areas of pixels which must always be absorbing to areas of pixels which can be used to modulate incident light. This does not affect the principal mechanism of brightness loss of a conventional colour reflective display, where coloured sub-pixels are distributed over the display plane.

WO2005/124404 proposes an arrangement which may be used in a reflective display panel or a solar panel. The arrangement comprises a colour filtering optical structure which separates ambient light on the front of the display and directs light of the appropriate colours to respective sets of pixels.

U.S. Pat. No. 6,064,452 proposes a transmissive liquid crystal display using a diffraction grating for colour filtering. The diffraction grating directs the red, green and blue light components to the red, green and blue pixels, respectively, of the display, either directly or via a lenticular screen.

U.S. Pat. No. 6,104,446 proposes a transmissive liquid crystal display. A micro-prism colour separation plate splits white light and directs red, green and blue components to the red, green and blue pixels of the display.

US2007/0268426 A1 proposes transmissive liquid crystal display. A backlight is provided with a colour separation sheet, for example in the form of a diffraction grating. A lenticular sheet focuses light from the grating such that the red, green and blue components are directed to the red, green and blue pixels of the display.

U.S. Pat. No. 6,122,465 proposes a reflective liquid crystal display using a hologram as a colour filter. Ambient light is converted to parallel light and the hologram then directs the red, green and blue components to the red, green and blue pixels, respectively, of the liquid crystal display.

### SUMMARY OF THE INVENTION

A first aspect of the invention provides reflective colour display apparatus comprising: a display device comprising reflective light-modulating pixels; and an optical structure arranged to concentrate light of a plurality of colours onto pixels of a plurality of sets, respectively; wherein the display device comprises a relief structure having reconfigurable contents for modulating light.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

The present invention will be further described, by way of example, with reference to the accompanying drawings, in which:

FIG. 1 shows a two-colour display;

FIG. 2 shows a two-colour display using parabolic reflectors;

FIG. 3 shows the repeat unit for the sub-pixels in a display having overlapping hexagonal concentrators;

FIG. 4 shows the light concentrator of FIG. 3 seen from a direction parallel to two edges of each end of the concentrator;

FIG. 5 shows the arrangement of the top edges of all three reflective colour filters together in a display having the concentrators of FIG. 3;

FIG. 6 shows two views of a sub-pixel of another display;

FIG. 7 shows the arrangement of colour filters for the display having the sub-pixels of FIG. 6;

FIG. 8 shows another side view of the sub-pixel of FIG. 6;

FIG. 9 shows a side view of the sub-pixel of FIG. 6, with added reflective vertical surfaces;

FIG. 10 shows the sub-pixel of a further display;

FIG. 11 shows the increase in viewing freedom when an optical structure is embedded in a high-index medium;

FIG. 12(a) shows a structure having reconfigurable contents for modulating light;

FIG. 12(b) shows a two-colour display incorporating the structure of FIG. 12(a);

FIGS. 12(c) and 12(d) illustrate two operating states of the structure of FIG. 12(a);

FIG. 13(a) shows another structure having reconfigurable contents for modulating light;

FIG. 13(b) shows another structure having reconfigurable contents for modulating light; and

FIG. 14 shows another structure having reconfigurable contents for modulating light.

### DESCRIPTION OF EMBODIMENTS

### Example One

### Two-Colour Display

A colour reflective display comprises optical structures and an array of sub-pixel light modulators. The optical structures concentrate light of different colours into different sub-pixel modulators.

In a conventional three-colour reflective display, only about one-third of the total incident light can be reflected, because of the loss of two thirds of the light at each colour filter. For example, green and blue light are absorbed at a red-transmitting filter. Using the present displays, brightness is increased by concentrating light of different colours into different sub-pixels. The green and blue light do not arrive at the red-modulating area and so do not need to be absorbed by the red-transmitting filter.

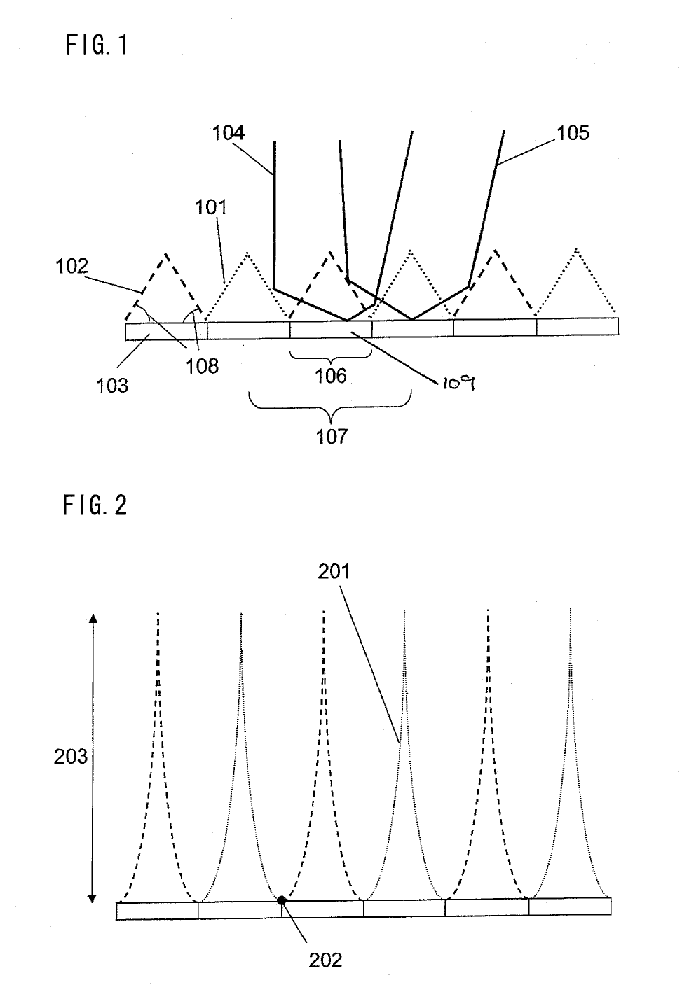

A two-colour display is shown in FIG. 1. Dotted lines 101 represent colour filters which reflect green and transmit red and blue (magenta) light. Dashed lines 102 represent colour filters which transmit green and reflect magenta light. This is a cross section of the display and the filters can be taken to continue a distance into the page, for a display over two dimensions. Reflective light modulating sub-pixels 103, for example planar sub-pixels, are placed below the colour filters as shown. Example paths for green light (104) and magenta light (105) are shown.

The colour filters 101, 102 of FIG. 1 together form an optical structure arranged to concentrate light of a plurality of colours onto pixels of a plurality of sets. In the example of FIG. 1 there are two sets of pixels, namely a set of green pixels and a set of magenta pixels, but the invention is not limited to a set of green pixels and a set of magenta pixels, and is not even limited to two sets of pixels. The colour filters that reflect green light direct green light onto a pixel of the set of green pixels, and the colour filters that reflect magenta light direct magenta light onto a pixel of the set of magenta pixels.

Furthermore, each pixel in the display of FIG. 1 is optionally associated with a respective sub-structure of the optical structure which passes light in a first part of the visible spectrum propagating towards the pixel and which redirects light in a second part of the visible spectrum propagating towards the pixel to another of the pixels, optionally towards an immediately adjacent pixel. Consider the pixel labelled 109 in FIG. 1 as an example. This is a green pixel, and is associated with a sub-structure defined by colour filters 102 which transmit green light and reflect magenta light. Thus, green light propagating towards pixel 109 is passed by the sub-structure associated with that pixel as shown by path 104, but magenta light propagating towards pixel 109 is reflected by the sub-structure associated with that pixel and, as shown by path 105, is redirected towards another pixel (optionally an adjacent pixel as also shown by path 105), which is a magenta pixel.

Because of the arrangement of the colour filters, only green light will arrive at the sub-pixel 109 in area 106. However, this green light is concentrated onto area 106 from the whole of area 107, which is considerably greater. In fact, this example can be arranged so that substantially no brightness is lost in the use of different coloured sub-pixels and the two-colour display has substantially the full contrast of the light modulator 103 when viewed on axis.

In the example of FIG. 1 the display is a two-colour display having green pixels and magenta pixels. The invention is not however limited to this. Optionally, the display has an optical structure such that each pixel in the display is associated with a respective sub-structure of the optical structure which passes light in a first part of the visible spectrum propagating towards the pixel and which redirects light in a second part of the visible spectrum propagating towards the pixel to another of the pixels, and where the first part of the visible spectrum includes at least one primary colour and the second part of the visible spectrum includes at least one other primary colour.

Moreover, to ensure that incident light is used as efficiently as possible, the display may optionally have an optical structure that is arranged to pass light of first and second colours, propagating towards first and second ones of the pixels, respectively, to the first and second pixels, respectively, and to redirect light of the second and first colours, propagating towards the first and second pixels, respectively, to the second and first pixels, respectively. Thus, in the example of FIG. 1 the optical structure defined by the colour filters 101, 102 is arranged to pass green light propagating towards a green pixel to the green pixel, to pass magenta light propagating towards a magenta pixel to the magenta pixel, to redirect green light propagating towards a magenta pixel to a green pixel, and to redirect magenta light propagating towards a green pixel to a magenta pixel.

Optionally, the first colour comprises a first primary colour and the second colour comprises second and third primary colours—in the display of FIG. 1, for example, the colour filters 101 represent colour filters which reflect green light and transmit red and blue (magenta) light, and dashed lines 102 represent colour filters which transmit green light and reflect red and blue (magenta) light. This provides a full colour display.

In a further example the display may have an optical structure arranged such that the sub-structures comprise first, second and third sets which pass red, green and blue colours, respectively, and redirect other colours. This also provides a full-colour display (namely an RGB display).

The reflective filters may be planar dielectric interference filters or higher-dimensional photonic crystals, for example. The light modulators may be electrophoretic or electrowetting display cells, or any other reflective light modulator.

In one version of this example, the angles labelled 108 are 70° and the modulators 103 are specular reflectors of visible light of all wavelengths in their white state. The colour filters are surrounded by air or a higher refractive index medium, above and below. (If a higher refractive medium, the interface between this and the air outside the system is parallel to the plane of the display.) According to geometric optics, all light incident normal to the plane of the display is reflected normal to the display. That is, because of the arrangement and optical properties of the colour filters, there is no loss of reflectance of the display as a result of modulating different coloured light in different areas.

FIG. 2 is essentially the same system as FIG. 1, but with colour filters in the shape of parabolic reflectors instead of planar surfaces. The two-colour arrangement leads to an acceptance angle of 30° for this system, if arranged as follows. The foci of the parabolic surfaces are such that the parabolic reflective colour filter 201 has its focal point at point 202, etc.; the height of the filters (203) is 5.2 times the width of a sub-pixel; and the parabolic reflectors are at right angles to the display plane at this height. This information can be calculated from design principles for this type of concentrator (the compound parabolic concentrator) found in ‘High Collection Nonimaging Optics’, Welford and Winston, Academic Press 1989, pages 55 to 62.

This two-colour display will have no loss of brightness from the use of colour and the full contrast ratio of the modulator up to the acceptance angle, whereafter the contrast ratio is zero.

Modifications to this design can be used, which have lesser performance but are easier to produce. The height of the filters can be decreased, for example, which does not have a significant effect on the efficiency of the concentrator for this concentration ratio (length 107 divided by length 106) of two. Three-dimensional compound parabolic reflectors can be used for three colour displays, although they do not concentrate perfectly as two-dimensional ones can.

### Example Two

### Overlapping Hexagonal Concentrators

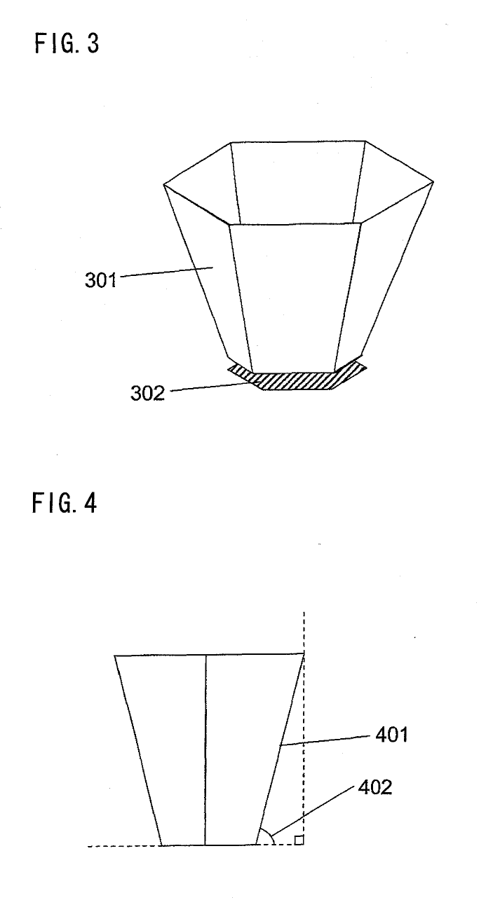

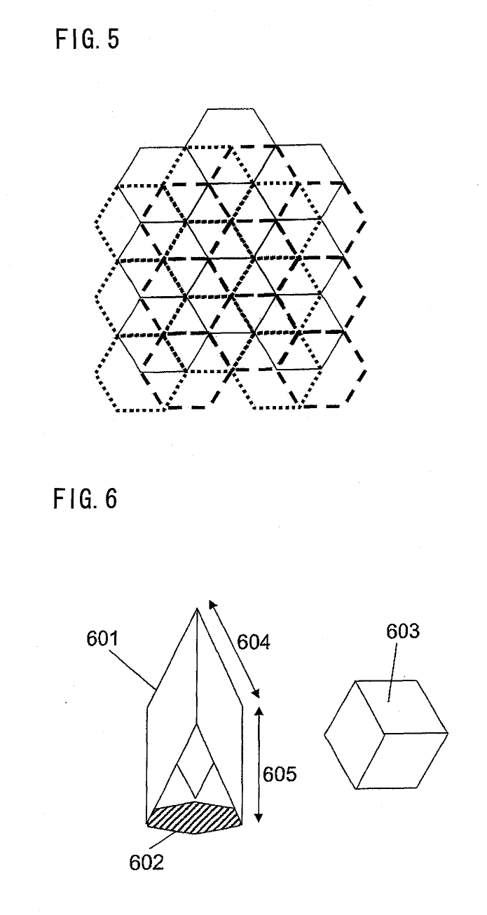

This example is illustrated in FIGS. 3, 4 and 5. Each sub-pixel of this display comprises of a hexagonal light concentrator (301); whose faces are filters which reflect light of one of the colours (e.g. red), transmitting the other two (e.g. green, blue); and a light modulator (302). The light modulator controls how much of the concentrated light of the one colour is reflected back from the display. The large end of the concentrator (301) is a regular hexagon with sides twice as long as those of the small end and the modulator (302), which are also regular hexagons, concentric with the large end of the modulator. A side view of the concentrator (401) is shown in FIG. 4.

Let the concentrators of FIG. 3 be arranged in an array containing three sets of concentrators, one reflecting only red light, one green and one blue, with all non-reflected light being transmitted. The arrangement of this array is depicted in FIG. 2. The edges at the large ends of the different concentrators are shown, with other edges omitted for clarity. The different styles of line indicate the edges of concentrators which reflect different colours. For example, the thin solid lines may indicate the top edges of red-reflecting concentrators, dashed may indicate green and dotted may indicate blue. Not depicted in the drawing, the hexagons at the small end of the light concentrators, and thus the light modulators, tessellate.

Let angle 402 of FIG. 4 be 70°. Now let light be incident normal to the concentrators and let the modulator (302) be a specular reflector in its white state. Again, according to geometric optics, all light of the concentrated colour arrives at the modulator and is reflected by it in its white state, back along the normal direction.

Therefore, a display with the overlapping colour concentrators of FIG. 5 will be able to reflect all light normally incident on it whilst splitting white light into three different colours to be modulated in different areas.

### Example Three

### Elongated Corner-Cubes

Reflective colour filters can be arranged in a pattern that could be referred to as elongated corner-cubes. FIG. 6 shows a sub-pixel of a display using this arrangement. 601 is the colour filter arrangement seen from the side and 602 the modulator for one of red, green and blue, depending on the properties of the colour filters 601. 603 is the sub-pixel seen from above; only the colour filter arrangement is visible, covering a hexagonal area on the plane containing the modulators. Length 604 is equal to length 605.

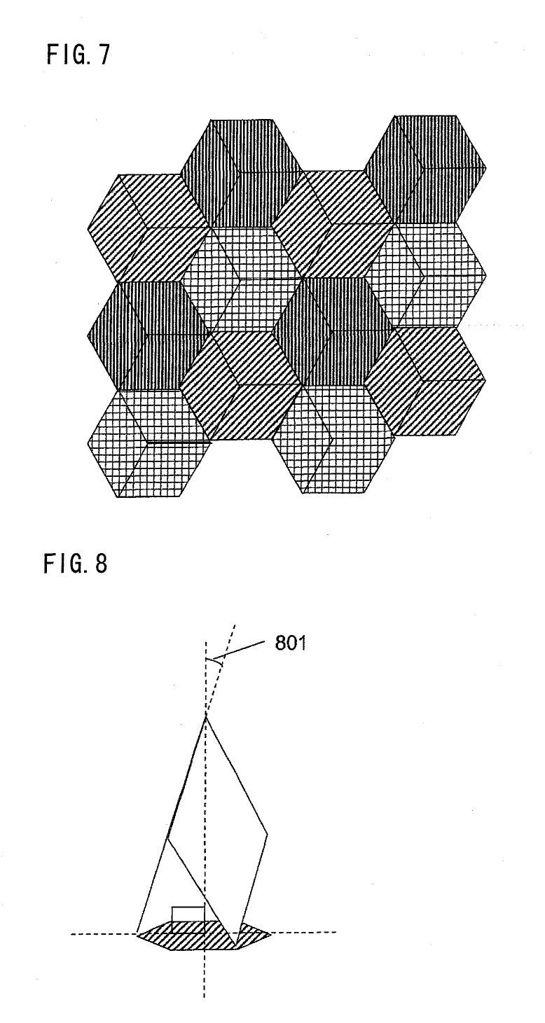

In this example, the colour filters transmit one of the three colours (e.g. red) while reflecting the other two (e.g. green, blue). The colour filters can be arranged in the pattern of FIG. 7, where the diagonally shaded areas transmit only red, the vertically shaded areas only green and the squared area only blue; all non-transmitted light is specularly reflected from the filters.

FIG. 8 shows another side view of the sub-pixel shown in FIG. 6. If angle 801 is 80°, simulations show that all red light, for example, incident normal to the display plane, will arrive at the hexagonal modulators underneath the red-transmitting elongated corner-cubes of FIG. 7.

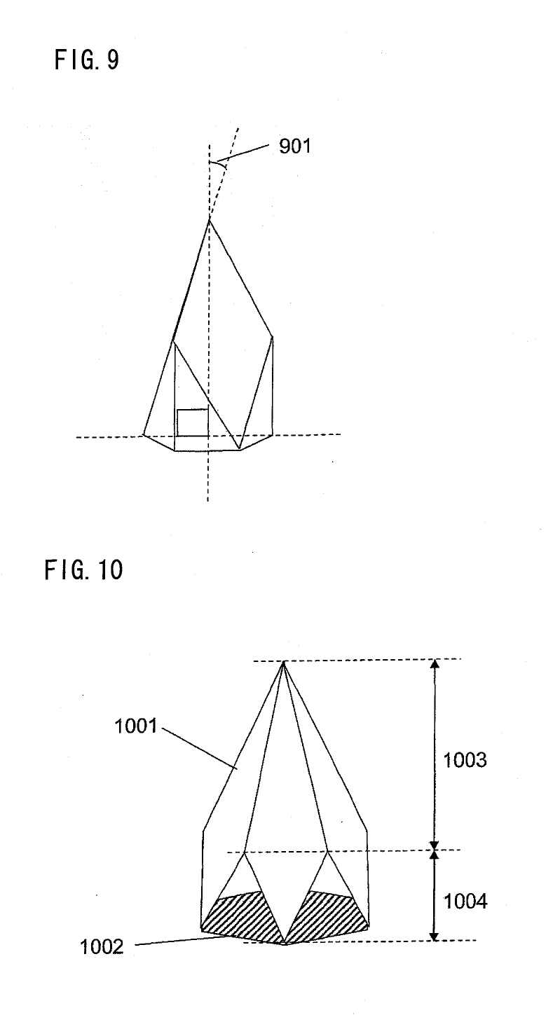

FIG. 9 shows the same sub-pixel, but with added vertical surfaces. These surfaces reflect white light.

If the sub-pixels of FIG. 9 are used in the arrangement of FIG. 7, and angle 901 is 80°, simulations show that all light incident at least up to 20° to the normal will be transmitted to the hexagonal modulators (all red light underneath the red-transmitting filters, etc.) and will be reflected out again. Thus all of the light arriving at the display at these angles is used, increasing brightness against a conventional colour reflective display where two thirds of the light is absorbed at every sub-pixel.

If the vertical reflecting walls of FIG. 9 are not used, and the modulators modulate white light, extra colour filters can be used over the modulators to avoid blue or green light being modulated by the sub-pixel designed to modulate red light. This is also appropriate to example four below.

### Example Four

### Hexagonal Pyramids

An analogous display to that of example three can be constructed from the repeat unit of FIG. 10, where 1001 is the arrangement of the colour filters of one sub-pixel and 1002 is the hexagonal light modulator for the sub-pixel. Length 1003 is twice length 1004.

These examples are simple examples that illustrate the principles of the display. There are many more possibilities, for example using curved surfaces and sub-pixel structures with different numbers of faces.

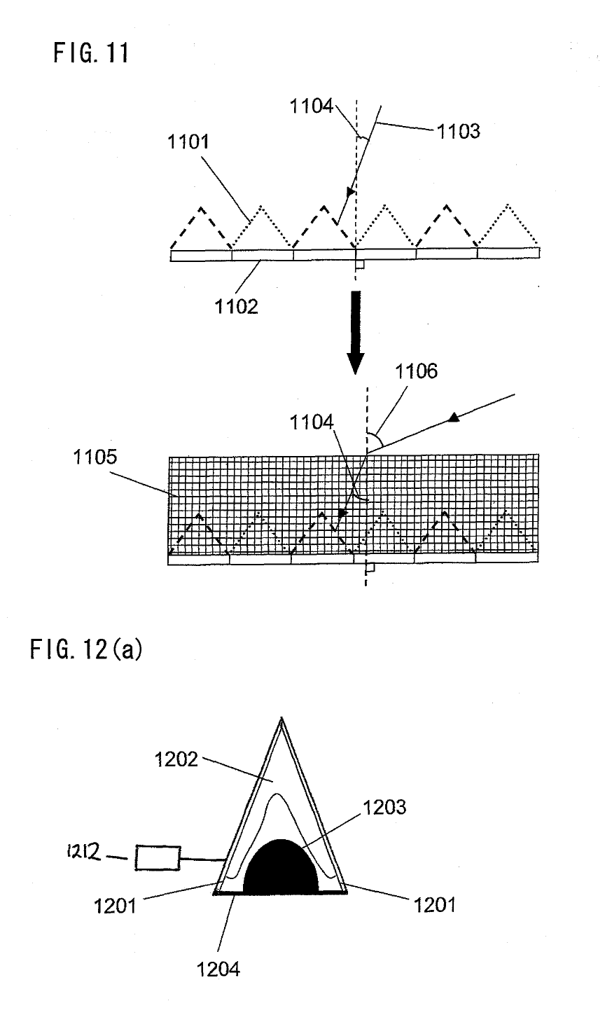

As a further variation, the arrangement of colour filters can be embedded in a high refractive index medium (e.g. a polymer). Where an example works for a particular range of angles when the colour filters are surrounded by air, It will work for a larger range of angles when embedded in a high refractive index material (for example, with its top surface parallel to the plane of the display and its bottom surface at the light modulators). FIG. 11 illustrates this.

A two colour display is set up, with colour filters 1101 and light modulators 1102. A light ray 1103 is incident upon the display at an angle 1104 to the normal. Now the colour filters are embedded in another medium 1105; glass or a polymer, for example. If the angle inside the medium is the same (1104), the external angle 1106 will be larger than if the optical structure was situated in air.

For example, if light incident (or reflected) at an angle 1104 of between 0 and 30° was considered to result in an acceptable performance, then if the filters were embedded in a medium 1105 of refractive index 1.6, the new range of acceptable angles outside the system would be 0 to 53°, using Snell's Law.

A high refractive medium can also be used only above, or only below the colour filter arrangement, so that the colour filters are disposed between media of different refractive indices. For example, the colour filters of example 1 (page 3) and FIG. 1 could be situated on an array of glass or polymer triangular prisms, which are in optical contact with the light modulators.

The light modulators can be scattering in their reflective state, which will alter the reflectance of the display at different viewing angles. The strength of the scattering can be chosen appropriately. Alternatively, the light modulators could have a planar reflective surface not parallel to the plane of the display, or reflective surfaces at more than one angle.

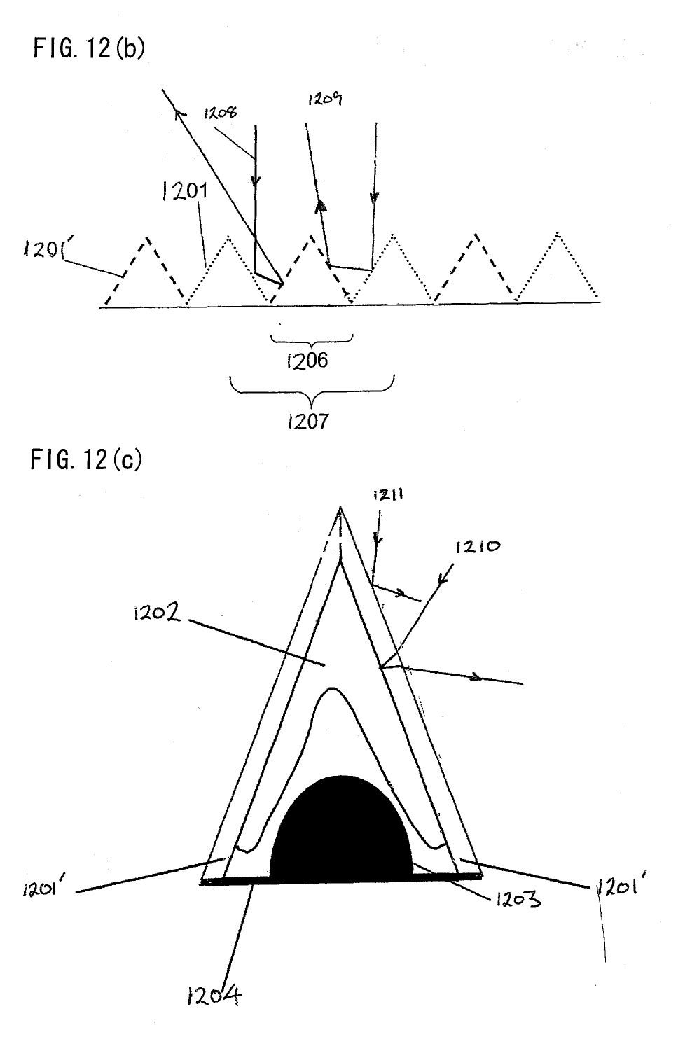

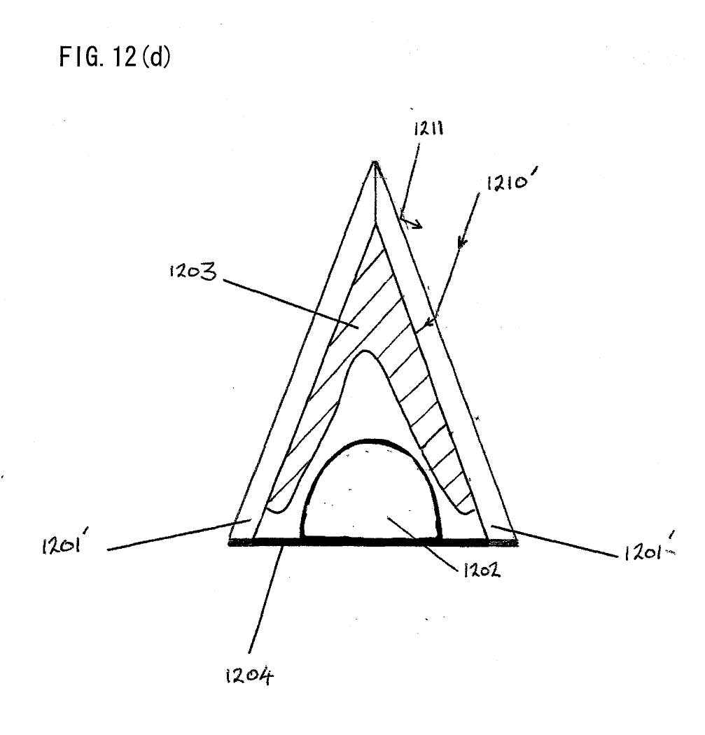

A display according to a further embodiment of the invention will now be described with reference to FIGS. 12(a) to 12(d). This embodiment is described with reference to a two-colour display, in particular a green-magenta display as in FIG. 1, but this embodiment is not limited to this.

FIG. 12(a) shows a structure having reconfigurable contents for modulating light. The principle of operation of the structure is that the structure contains two fluids, for example two liquids, having different optical properties to one another, such that one or other of the fluids can be put in a path of light.

In the structure of FIG. 12(a), the reflective colour filters (1201) form part of a relief structure enclosing two immiscible fluids (1202 and 1203), for example two immiscible liquids. 1204 is the base of the enclosing structure. One of these fluids is reflecting (1202) for light over the intended range of operating wavelengths, for example over the entire visible spectrum, and the other is absorbing (1203) for light over the intended range of operating wavelengths, for example over the entire visible spectrum. These liquids can be moved around within the enclosing structure, for example by having at least one of the fluids 1202, 1203 as a polar fluid and using electrostatic charges on the inside of the enclosing structure, to produce different total reflectivities of the structure. For example, in the arrangement shown, with the reflective liquid 1202 positioned directly underneath the colour filters 1201, the sub-pixel would be maximally reflective. If however the absorbing liquid 1203 were covering the undersides of the colour filters 1201, the sub-pixel would be maximally absorbing.

Suitable liquids for the reflective liquid 1202 include, for example mercury, or a colourless ionic liquid (for example potassium chloride (KCl) dissolved in water) containing scattering particles (such as titanium dioxide, TiO₂) dispersed therein. Suitable liquids for the absorbing liquid 1202 include, for example, an oil containing a light-absorbing dye.

FIG. 12(b) shows a display, in this example a two colour display, that incorporates structures as shown in FIG. 12(a). The display is in many ways similar to the display of FIG. 1, in that structures with colour filters 1201′ that transmit green light and reflect magenta light alternate with structures with colour filters 1201 that reflect green light and transmit magenta light. (In fact the structures are arranged in a two-dimensional array, with structures with colour filters 1201′ that transmit green light and reflect magenta light alternating with structures with colour filters 1201 that reflect green light and transmit magenta light along both the row and column directions.)

The operation of a structure of FIG. 12(a) is shown in more detail in FIGS. 12(c) and 12(d). These figures illustrate operation of a structure having colour filters 1201′ that transmit green light and reflect magenta light.

FIG. 12(c) shows the structure in its state when the reflective liquid 1202 is disposed directly underneath the colour filters 1201′. The colour filters 1201′ pass light in a first part of the visible spectrum that is propagating towards the pixel and redirect light in a second part of the visible spectrum to a neighbouring structure. In the specific example of FIG. 12(c) green light incident on the structure is transmitted through the colour filter, undergoes reflection at the interface between the inner surface of the colour filter 1201′ and the reflective liquid 1202, and is then transmitted back through the colour filter 1201′ as shown by ray path 1210. Depending on the angle of incidence of the ray path 1210 the reflected green light may be emitted from the display directly, or may be emitted from the display after undergoing reflection by an adjacent structure having colour filters that reflect green light and transmit magenta light.

FIG. 12(d) shows the structure in its state when the absorbing liquid 1203 is disposed directly underneath the colour filters 1201′. Green light incident on the structure is transmitted through the colour filter but is then absorbed by the absorbing liquid 1203 as shown by ray path 1210′, so that no (or little) green light is reflected by the structure. The intensity of green light reflected by the structure may therefore be controlled by controlling the reflective liquid 1202 or the absorbing liquid 1203 to be directly underneath the colour filters 1201′.

Magenta light incident on the structure is reflected by the external surface of the colour filters, regardless of whether the reflective liquid 1202 or the absorbing liquid 1203 is directly underneath the colour filters 1201′, as shown by ray path 1211.

A structure having colour filters 1201 that reflect green light and transmit magenta light operates in an analogous way—the intensity of magenta light reflected by the structure may be controlled by controlling the reflective liquid 1202 or the absorbing liquid 1203 to be directly underneath the colour filters 1201, and green light is reflected by the external surface of the colour filters 1201, regardless of whether the reflective liquid 1202 or the absorbing liquid 1203 is directly underneath the colour filters 1201.

In the display of FIG. 12(b) therefore, green light that is reflected by a structure with colour filters 1201 that reflect green light and transmit magenta light will not pass through the adjacent structure as shown in FIG. 1, but instead will pass through a colour filter 1201′ of the adjacent structure (which transmits green light and reflects magenta light), and will then either undergo reflection at the interface between the inner surface of the colour filter 1201′ and the reflective liquid 1202 (as described with reference to FIG. 12(c)) or be absorbed by the absorbing liquid 1203 (as described with reference to FIG. 12(d)). Ray paths 1208 and 1209 illustrate paths of green light that is incident on a structure with colour filters 1201 that reflect green light and transmit magenta light. Conversely, magenta light that is reflected by a structure with colour filters 1201′ that reflect magenta light and transmit green light will not pass through the adjacent structure as shown in FIG. 1, but instead will pass through the colour filter 1201 of the adjacent structure (which transmits magenta light and reflects green light), and will then either undergo reflection at the interface between the inner surface of the colour filter 1201 and the reflective liquid 1202 or be absorbed by the absorbing liquid 1203.

Thus, in the display of FIG. 12(b) the structures again act to concentrate light of a plurality of colours onto pixels of a respective set from a plurality of sets. In the example of FIG. 12(b) the structures having colour filters 1201′ that transmit green light and reflect magenta light act as a set of green pixels since they modulate the intensity of green light reflected by the display, whereas the structures having colour filters 1201 that transmit magenta light and reflect green light act as a set of magenta pixels since they modulate the intensity of magenta light reflected by the display. As indicated in FIG. 12(b), the extent 1207 of a collecting area for a pixel is greater than the extent 1206 of a pixel.

In the embodiment of FIGS. 12(a) to 12(d), light is modulated (absorbed) at the inner surface of the colour filter 1201, 1201′, which thus acts as light-modulating region. The modulators 103 of FIG. 1 are therefore not required. Carrying out the absorption (modulation) at the colour filter 1201, 1201′, instead of at the back plane as in the display of FIG. 1, decreases the light level for the black state of the display dramatically and therefore can increase the contrast ratio of the display by factors of greater than 20.

It should be noted the modulation of light in the display of FIG. 12(b) takes place over the same area (in the plane of the display) as in the embodiment of FIG. 1—so that a viewer viewing the display of FIG. 1 and a viewer viewing the display of FIG. 12(b) would in each case see a matrix of pixels, with each pixel corresponding to one of the structures.

The structure includes a control system, shown schematically as 1212 in FIG. 12(a), for controlling one or other of the first and second fluids to be an optical path of light propagating towards the pixel. The control system controls whether the reflective liquid 1202 or the absorbing liquid 1203 is directly underneath the colour filters 1201 and could for example comprise electrodes and a voltage source (not shown) that allow the colour filters 1201,1201′ and the base 1204 to be electrically charged, independently from one another; this would be suitable when one of the liquids 1202, 1203 is an ionic liquid. For example, the liquid 1202 could be an ionic reflective liquid (such as KCl dissolved in water and containing light-scattering particles such as TiO₂ particles and the liquid 1203 could be a black hydrophobic liquid, for example an oil containing an absorbing dye. If the colour filters of the structure are electrically charged but the base 1204 is not charged the ionic, reflective liquid will cover the internal surface of the colour filters as shown in FIG. 12(c) and the black, hydrophobic liquid will be displaced by the ionic, reflective liquid so as to adjacent to the base 1204. If the base 1204 is electrically charged but colour filters are not charged, the ionic, reflective liquid will move to cover the base 1204 as shown in FIG. 12(d) and the black, hydrophobic liquid will be displaced to the upper regions of the feature so as to be adjacent to the inner surfaces of the colour filters.

This type of modulator arrangement allows the display of FIG. 12(b) to maintain a high contrast ratio over a larger range of angles than the display of, for example, FIG. 1. This is because there are some ray paths which do not reach the planar modulators 103 of FIG. 1, depending on angles 108—these rays are reflected back out of the system by the reflective filters 101 or 102. If however the light modulation takes place inside the triangular structure, as in FIGS. 12(a) and 12(b), light travelling along some of these paths can still be modulated.

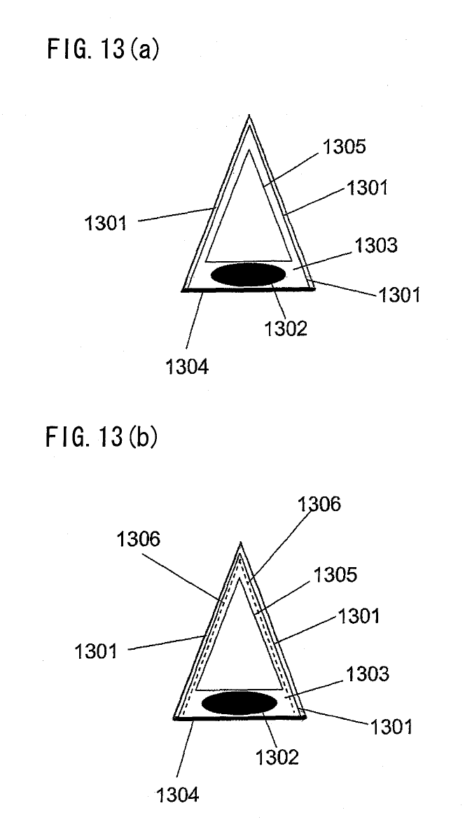

FIG. 13(a) shows another structure having reconfigurable contents for modulating light. The principle of operation of the structure of FIG. 13(a) is generally similar to that of the structure of FIG. 12(a), in that the structure contains two fluids, for example two liquids, of different optical properties such that one or other of the fluids can be put in a path of light.

The liquids (fluids) are in an enclosure defined by light transmissive plates 1301 and a base 1304 that may or may not be light-transmissive. The structure contains two liquids, which are a colourless (ie, light-transmissive) ionic liquid 1303 (e.g. KCl in solution in water) and a black (light-absorbing), hydrophobic liquid 1302 (for example an oil containing a light-absorbing dye). One or more internal surfaces 1305 are provided inside the enclosure, and the liquids are confined between internal surface 1305 and the inside faces of the light transmissive plates 1301 and base 1304. The internal surfaces 1305 is also, or is provided with, an electrode in contact with ionic liquid 1303, electrically connecting the ionic liquid to ground.

The structure is provided with electrodes (not shown) for charging the plates 1301 and the base 1304, independently of one another. For example, plates 1301 and base 1304 can be made of a transparent conductor, covered by an electrically insulating layer and with a hydrophobic surface in contact with the liquids. When a voltage is applied between this surface and another, the surface becomes charged and it becomes hydrophilic. Alternatively, separate transparent electrodes may be provided on the internal surfaces of the plates 1301.

If the plates 1301 are electrically charged, the ionic, colourless liquid 1303 will cover the inside faces of the plates and the black, hydrophobic liquid 1302 will be hidden beneath surface 1305 (as shown in FIG. 13(a)). In embodiment in which the surfaces 1305 are light-reflective, the structure will reflect white light. If however the base 1304 is charged but the plates 1301 are not charged, the ionic, colourless liquid will move to be adjacent the base 1304 and the black, hydrophobic liquid will be displaced to the upper regions of the feature and be visible through plates 1301. Now the structure will absorb light that is incident on the plates 1301. Thus, as for the structure of FIG. 12(a), light modulation can be effected by re-positioning the liquids 1302, 1303 by electrically charging either the plates 1301 or the base 1304.

In a modification of this embodiment, the surfaces 1305 may be transparent and the base 1304 may be reflective. When the ionic, colourless liquid 1303 covers the inside faces of the plates, light incident on the plates 1301 is transmitted through the surfaces 1305, and is reflected back out of the structure by the base 1304.

As for the structure of FIG. 12(a), carrying out the absorption (modulation) at surfaces 1301, instead of at the back plane, decreases the light level for the black state of the display dramatically and therefore can increase its contrast ratio by factors of greater than 20.

In order to obtain a colour display, colour filters may be provided on the light-transmissive plates 1301, such that the structure modulates light of one wavelength range (for example one primary colour) while diverting other wavelengths (eg the other primary colour(s)) to adjacent structures to be modulated there, or to the viewer, having already been modulated at nearby features. For example, a display may be formed by providing some structures of FIG. 13(a) with colour filters that transmit green light and reflect magenta light and arranging these alternately with structures having colour filters that transmit magenta light and reflect green light by.

It should be noted that the structure of FIG. 13(a) may alternatively be implemented by using colour filters as the light-transmissive plates 1301, as in the structure of FIG. 12(a). Conversely, the structure of FIG. 12(a) may alternatively be implemented by forming the enclosure for the fluids from light-transmissive plates to provide a structure that may module white light, and providing colour filters that are additional to the light transmissive plates.

FIG. 12(a) shows a space between the reflective fluid 1202 and the absorbing fluid 1203. This could be occupied by a third fluid, for example one that is not influenced by an electrical field. Alternatively, the reflective fluid 1202 and the absorbing fluid 1203 could completely or almost completely fill the free space inside the structure. Conversely, FIG. 13(a) shows the transmissive fluid 1303 and the absorbing fluid 1302 as filling the free space inside the structure, but in principle the structure could further contain a third fluid, for example one that is not influenced by an electrical field.

The invention is not limited to the specific structures having reconfigurable contents for modulating light that are described with reference to FIGS. 12(a) and 13(a). For example, the structure may operate on the principle of electrophoresis and contain a single fluid, for example a liquid, that contains two (or more) dispersed species having different optical properties to one another so that the transmissivity of an optical path in the structure is dependent on which of the dispersed species is present in the optical path. The appropriate application, or switching, of an electric field does not move the fluid around, but would bring one of the dispersed species to the surface and would therefore change the transmissivity of an optical path in the structure and thus modulate light. The fluid containing the particles could for example be disposed between surfaces such as the plates 1301 and the internal surfaces 1305 of FIG. 13(a), and the appropriate application, or switching, of an electric field to the liquid could change the transmissivity of an optical path between the plates 1301 and the internal surfaces 1305. As in the embodiment of FIG. 13(a), the internal surfaces 1305 may be reflective, or they may be transparent and the base 1304 of the fluid enclosure may be reflective.

A suitable fluid for this embodiment is a colourless liquid that contains particles of two different types, one type being light-absorbing and the other type being light-scattering (reflective), with particles of one type having opposite electrical charge to particles of the other type. When the light-absorbing particles are brought, by appropriate application or switching of an electric field, to surfaces of the structures where light is incident, they will absorb incident light; however, when the scattering particles are, by appropriate application or switching of an electric field, brought to surfaces of the structures where light is incident, incident light is scattered and reflected by the scattering particles.

Alternatively, the structure may contain a light-absorbing liquid that has scattering particles dispersed therethrough (for example an oil containing a light-absorbing dye and TiO₂ scattering particles). The scattering particles are required to be electrically charged so that an electric field will cause them to migrate to a particular surface. When the scattering particles are brought, by appropriate application or switching of an electric field, to surfaces of the structures where light is incident, they will scatter and reflect incident light so that light is not absorbed by the oil/dye—and the structure is reflective. However, when the scattering particles are, by appropriate application or switching of an electric field, removed away from surfaces of the structures where light is incident, incident light is absorbed by the oil/dye, and the structure does not reflect light.

As another example, a structure having reconfigurable contents for modulating light might include a liquid crystal material that can be electrically driven into one of two states having different optical properties in order to change the transmissivity of an optical path in the structure. For example, a liquid crystal material with a switchable cholesteric mode (as used by Kent Displays) could be used, and could be switched between a reflective state and a transmissive state. Again, the liquid crystal material could be disposed on the inside surface of a plate 1301 of the structure of FIG. 13(a), with electrodes provided on the plates 1301 and the internal surfaces 1305 for addressing the liquid crystal material.

As another example, a structure having reconfigurable contents for modulating light might be effected by providing a MEM (microelectromechanical) system in the structure. For example a MEM system could be provided on or behind the inside faces of the transmissive plates 1301 of FIG. 13(a) or on the inside faces of the colour filters 1201,1201′ of FIG. 12(a), and the MEM system could be switched between a light-absorbing state and a light-reflecting state.

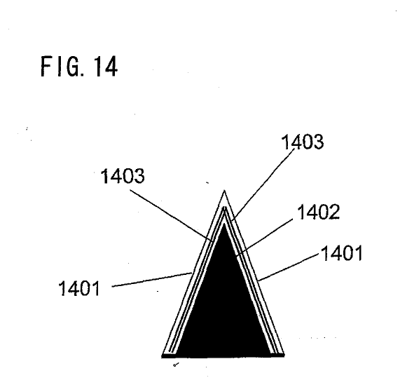

FIG. 14 shows a further structure having reconfigurable contents for modulating light. The structure of FIG. 14 contains an MEM system. In FIG. 14, the structure comprises colour filters 1401 that transmit light of at least one primary colour reflect light of at least another primary colour (for example, they may transmit green light and reflect magenta light or vice versa). The structure further includes an MEMS reflector 1403, which can be moved so that it either reflects or transmits light that is transmitted by the colour filters 1401. The structure further includes an absorber 1402 which can absorb light any light that is not reflected by the MEMS reflector 1403. Thus, the MEMS reflector 1403 can be controlled such that light that is transmitted by the colour filters 1401 either is reflected back out of the structure by the MEMS reflector 1402 or is not reflected by the MEMS reflector and so is incident on, and is absorbed by, the absorber 1402.

It should be noted that the structure of FIG. 14 may alternatively be implemented by forming the enclosure for the fluids from light-transmissive plates to provide a structure that may module white light, and providing colour filters that are additional to the light transmissive plates.

In the embodiments so far described, the means of concentrating each colour into different areas has been arranging reflective colour filters. Other optical structures can be used, e.g. diffractive or dispersive structures.

If colour filters are used, the colour filters may comprise interference structures. It is desirable to use interference structures in more than one dimension, so that angular dependence of their transmission and reflection properties is minimised. Three dimensional photonic crystals are suitable because of their relatively angle-independent properties. A mass-producible three-dimensional photonic crystal has been developed by Baumberg et al. (‘Nanoparticle-tuned structural color from polymer opals’, Pursiainen et al., Optics Express 15 (15), p 9553, 2007) The angle-independent nature of two-dimensional structures has also been recognised. (‘High angular tolerant color filter using subwavelength grating’, Cheong et al., Applied Physics Letters 94, p 213104, 2009).

As well as using means of separating light of different colours, so that it falls on different modulating areas, absorbing colour filters can be used as “clean-up absorbing colour filters” to absorb stray light. As an example, a filter could be used to absorb stray green and blue light arriving at the area intended for modulating red light. The use of “clean-up absorbing colour filters” is shown in FIG. 13(b), which shows a further structure having reconfigurable contents for modulating light. The structure of FIG. 13(b) is generally similar to the structure of 13(a), and the description of components of the structure of FIG. 13(b) that are the same as components of the structure of 13(a) will not be repeated. The structure of FIG. 13(b) comprises one or more additional colour filters 1306 which act as “clean-up absorbing colour filters” (two such additional colour filters 1306 are shown in FIG. 13(b), but the invention is not limited to this and one clean-up additional colour filter or more than two additional colour filters could be provided). The additional colour filters 1306 are provided on the inside surface of the structure, for example on the inside surfaces of the plates 1301. The additional colour filters 1306 pass light of a wavelength, or wavelength range, that the structure is intended to modulate, and block light that is outside this wavelength, or wavelength range.

Any components provided on the internal surfaces of the plates 1301 in the embodiment of FIG. 13(a), such as a transparent electrode, would be placed on the internal surface of the clean-up filter 1306 in the embodiment of FIG. 13(b). Additional colour filters to act as clean-up absorbing colour filters may be provided in a structure according to any embodiment.

An optical structure which concentrates light of different colours onto different areas can also be used to increase the signal, and thus the signal to noise ratio, of a camera. This is true for cameras where the detector is split into different areas to detect light of different colours, e.g. current digital cameras. For example, in the embodiment of FIG. 13(a) a light sensor could be provided behind the base 1304, with the base 1304 and the colourless fluid 1303 being transparent.

In these devices, RGB colour filters are used to absorb light of two colours and transmit one to a sensor. If a colour-concentrating optical structure is used, the signal at each colour sensor may be increased by up to a factor of around 3, since no light is absorbed.

For example, the light modulator 302 in FIG. 3 can be replaced by a light sensor. Then an array of colour filters and sensors according to FIGS. 3 and 5 and 2 can result in all red light being concentrated to sensors for red light, etc.

The limited range of angles of incidence at the sensor in a camera increases the design freedom for the optical structure, relative to displays where a viewing angle of 90° in all directions is desired.

Some embodiments of the present invention disclose a colour sensor apparatus comprising: a sensor device comprising light-sensitive pixels; and an optical structure arranged to concentrate light of a plurality of colours onto pixels of a plurality of sets, respectively.

Some embodiments of the present invention disclose an apparatus in which the pixels are planar.

Some embodiments of the present invention disclose a display apparatus, in which the display device comprises a relief structure having reconfigurable contents for modulating light.

Some embodiments of the present invention disclose a camera comprising a sensor apparatus.

Some embodiments of the present invention disclose a sensor device that may comprise light-sensitive pixels; and an optical structure arranged to concentrate light of a plurality of colours onto pixels of a plurality of sets, respectively.

Some embodiments of the present invention disclose a reflective colour display apparatus where each pixel may be associated with a respective sub-structure of the optical structure which passes light in a first part of the visible spectrum propagating towards the pixel to a light-modulating region and which redirects light in a second part of the visible spectrum propagating towards the pixel to another of the pixels.

Some embodiments of the present invention disclose a reflective colour display apparatus where the other pixel may be an immediately adjacent pixel.

Some embodiments of the present invention disclose a reflective colour display apparatus where the first part of the visible spectrum may include at least one primary colour and the second part of the visible spectrum includes at least one other primary colour.

Some embodiments of the present invention disclose a reflective colour display apparatus where additionally, the structure may be arranged to pass light of first and second colours, propagating towards first and second ones of the pixels, respectively, to the first and second pixels, respectively, and to redirect light of the second and first colours, propagating towards the first and second pixels, respectively, to the second and first pixels, respectively.

Some embodiments of the present invention disclose a reflective colour display apparatus where the first colour may comprise a first primary colour and the second colour may comprise second and third primary colours.

Some embodiments of the present invention disclose a reflective colour display apparatus where the first and second pixels may alternate in at least one direction.

Some embodiments of the present invention disclose a reflective colour display apparatus where the sub-structures may comprise first, second and third sets which pass red, green and blue colours, respectively, and redirect other colours.

Some embodiments of the present invention disclose a reflective colour display apparatus where the structure may comprise reflective colour filters.

Some embodiments of the present invention disclose a reflective colour display apparatus where the apparatus may comprise a medium of higher refractive index than air disposed on at least one side of the structure.

Some embodiments of the present invention disclose a reflective colour display apparatus where additionally or alternatively the structure may be disposed between media of different refractive indices.

Some embodiments of the present invention disclose a reflective colour display apparatus where the colour filters may comprise interference structures. Alternatively the colour filters may comprise a diffractive structure. Alternatively the colour filters may comprise a dispersive medium.

Some embodiments of the present invention disclose a reflective colour display apparatus where the structure may further comprise clean-up absorbing colour filters.

Some embodiments of the present invention disclose a reflective colour display apparatus where the sub-structure associated with a pixel may contain first and second fluids having different optical properties to one another, and a control system for disposing one or other of the first and second fluids in an optical path of light propagating towards the pixel.

Some embodiments of the present invention disclose a reflective colour display apparatus where the sub-structure associated with a pixel may alternatively contain a fluid having first and second dispersed species having different optical properties to one another, and a control system for disposing one or other of the first and second dispersed species in an optical path of light propagating towards the pixel.

Some embodiments of the present invention disclose a reflective colour display apparatus where the sub-structure associated with a pixel may alternatively contain a liquid crystal material arranged in an optical path of light propagating towards the pixel and being switchable between first and second dispersed states having different optical properties to one another.

Some embodiments of the present invention disclose a reflective colour display apparatus where the sub-structure associated with a pixel may alternatively contain a microelectricalmechanical (MEM) system arranged in an optical path of light propagating towards the pixel and being switchable between first and second states having different optical properties to one another.

Some embodiments of the present invention disclose a reflective colour display apparatus where it is possible to increase the brightness of a colour reflective display where the modulating regions for different coloured light are in the same plane (e.g. red, green and blue sub-pixel modulators). The total reflectivity and contrast ratio of a colour reflective display may be equal to that of monochrome light modulators used as part of it.

Some embodiments of the present invention disclose a reflective colour display apparatus where the brightness may be increased compared with a conventional reflective display, without introducing parallax between different coloured light modulators. This is an advantage over subtractive colour systems where the modulators (e.g. yellow, cyan, magenta) are arranged in a stack.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A reflective colour display apparatus comprising: a display device comprising reflective light-modulating pixels; and an optical structure arranged to concentrate light of a plurality of colours onto pixels of a plurality of sets, respectively; wherein the display device comprises a relief structure having reconfigurable contents for modulating light.

2. An apparatus as claimed in claim 1, in which each pixel is associated with a respective sub-structure of the optical structure which passes light in a first part of the visible spectrum propagating towards the pixel to a light-modulating region and which redirects light in a second part of the visible spectrum propagating towards the pixel to another of the pixels.

3. An apparatus as claimed in claim 2, in which the other pixel is an immediately adjacent pixel.

4. An apparatus as claimed in claim 2, in which the first part of the visible spectrum includes at least one primary colour and the second part of the visible spectrum includes at least one other primary colour.

5. An apparatus as claimed in claim 2, in which the structure is arranged to pass light of first and second colours, propagating towards first and second ones of the pixels, respectively, to the first and second pixels, respectively, and to redirect light of the second and first colours, propagating towards the first and second pixels, respectively, to the second and first pixels, respectively.

6. An apparatus as claimed in claim 5, in which the first colour comprises a first primary colour and the second colour comprises second and third primary colours.

7. An apparatus as claimed in claim 5, in which the first and second pixels alternate in at least one direction.

8. An apparatus as claimed in claim 2, in which the sub-structures comprise first, second and third sets which pass red, green and blue colours, respectively, and redirect other colours.

9. An apparatus as claimed in claim 1, in which the structure comprises reflective colour filters.

10. An apparatus as claimed in claim 9, comprising a medium of higher refractive index than air disposed on at least one side of the structure.

11. An apparatus as claimed in claim 9, in which the structure is disposed between media of different refractive indices.

12. An apparatus as claimed in claim 9, in which the colour filters comprise interference structures.

13. An apparatus as claimed in claim 1, in which the structure comprises a diffractive structure.

14. An apparatus as claimed in claim 1, in which the structure comprises a dispersive medium.

15. An apparatus as claimed in claim 9, in which the structure further comprises clean-up absorbing colour filters.

16. An apparatus as claimed in claim 2 wherein the sub-structure associated with a pixel contains first and second fluids having different optical properties to one another, and a control system for disposing one or other of the first and second fluids in an optical path of light propagating towards the pixel.

17. An apparatus as claimed in claim 2 wherein the sub-structure associated with a pixel contains a fluid having first and second dispersed species having different optical properties to one another, and a control system for disposing one or other of the first and second dispersed species in an optical path of light propagating towards the pixel.

18. An apparatus as claimed in claim 2 wherein the sub-structure associated with a pixel contains a liquid crystal material arranged in an optical path of light propagating towards the pixel and being switchable between first and second dispersed states having different optical properties to one another.

19. An apparatus as claimed in claim 2 wherein the sub-structure associated with a pixel contains a microelectricalmechanical (MEM) system arranged in an optical path of light propagating towards the pixel and being switchable between first and second states having different optical properties to one another.
